(19) United States
(12) Patent Application Publication
(10) Pub. No.: US 2010/0313429 A1
(43) Pub. Date: Dec. 16, 2010

(54) GRASS TRIMMER

(75) Inventors: Toshinari Yamaoka, Nanjing (CN); Haishen Xu, Nanjing (CN); Wei Jiang, Nanjing (CN)

Correspondence Address: GREENBERG TRAURIG, LLP, 77 WEST WACKER DRIVE, SUITE 3100, CHICAGO, IL, 60601-1732, US

(73) Assignee: Chervon Limited, Wanchai (HK)

(21) Appl. No.: 12/797,062

(22) Filed: Jun. 9, 2010

(30) Foreign Application Priority Data
Jun. 15, 2009 (CN) 200920047124.X

(51) Int. Cl. A01D 34/412; A01D 34/84; A01D 34/82

(52) U.S. Cl. 30/276; 30/277.4; 30/321

(57) ABSTRACT

A trimmer has a cutting head, a shaft rod, and at least one handle. The cutting head is rotatably mounted at one end of the shaft rod by a connection device which has a central axis. At least one handle is mounted on the other end of the shaft rod. The cutting head moves between a horizontal position and a vertical position by rotating the cutting head 97.5 degrees around the center axis.

### RELATED APPLICATIONS

This application claims the benefit of CH 200920047124.X filed on Jun. 15, 2009 the disclosure of which is incorporated herein by reference in its entirety.

### BACKGROUND

This disclosure relates to a grass trimmer, especially to a grass trimmer with at least two operating modes, namely, a grass trimming mode and an edge trimming mode.

A grass trimmer adapted for cutting grass or weeds usually includes a cutting head, a shaft rod and an operating handle. The cutting head and the operating handle are located on both ends of the shaft rod, respectively. The cutting head comprises a cutter element, which usually takes the form of a flexible plastic wire member or linear member wrapped around a reel, or a plastic cutter element which is essentially rigid. The cutter element is driven to rotate by a transmission mechanism powered by a motor or a gasoline engine.

The trimmer usually has two operating modes, that is, a trimming mode and an edging mode. In use, the cutting head of the trimmer is generally at a horizontal position for trimming grass of the lawn, which is in the so-called trimming mode. The cutting head of the trimmer can also be rotated to a vertical position for edging an edge of the lawn, which is in the so-called edging mode. If the trimmer is needed to be converted into the edging mode, the user may simply rotate the trimmer by 180 degrees, which often results in the user feeling uncomfortable due to the position of the handle. In some other trimmers, the cutting head can be rotated relative to the shaft or the handle to keep the handle stationary, and the user can grip the handle in a conventional manner. However, during the edging process, the user must move sideways along the edge, with a result that the eyes of the user cannot be in alignment with edge of the lawn, so that it is difficult for the user to align the cutter element accurately with the edge of the lawn, and this can lead to a poor edging performance.

### SUMMARY

An improved grass trimmer is described which includes an operating mode switching mechanism. To this end, the grass trimmer includes a cutting head, a shaft rod, and at least one handle where the cutting head is rotatably mounted at one end of the shaft rod by a connection device which has a central axis and where the at least one handle is mounted on the other end of the shaft. The cutting head can be moved between a horizontal position and a vertical position by rotating the cutting head 97.5 degrees around the center axis.

The connection device of the trimmer allows the cutting head to be rotated and located between the horizontal position and the vertical position by a simple and single rotary motion. Another advantage of the connection device is that when the trimmer is changed into the edging mode, the shaft is substantially parallel to the edge of the lawn so that the user can stand rearward of the cutting head and move forwardly (or backwardly) along the edge of the lawn, allowing the eyes of the user to be aligned with the cutting surface and the edge of the lawn. In this case, the edging operation is implemented.

### BRIEF DESCRIPTION OF THE DRAWINGS

The subject grass trimmer will be further described with reference to the accompanying figures, in which:

FIG. 1 is an illustrative view of a preferred embodiment of a trimmer constructed according to the disclosure that follows;

FIG. 2 is a partial sectional view of the trimmer shown in FIG. 1;

FIG. 3 is an illustrative view of the trimmer in an edging mode;

FIG. 4 is an illustrative view of a first connection element of a connection device of the trimmer; and

FIG. 5 is an illustrative view of a second connection element of the connection device of the trimmer.

### DETAILED DESCRIPTION

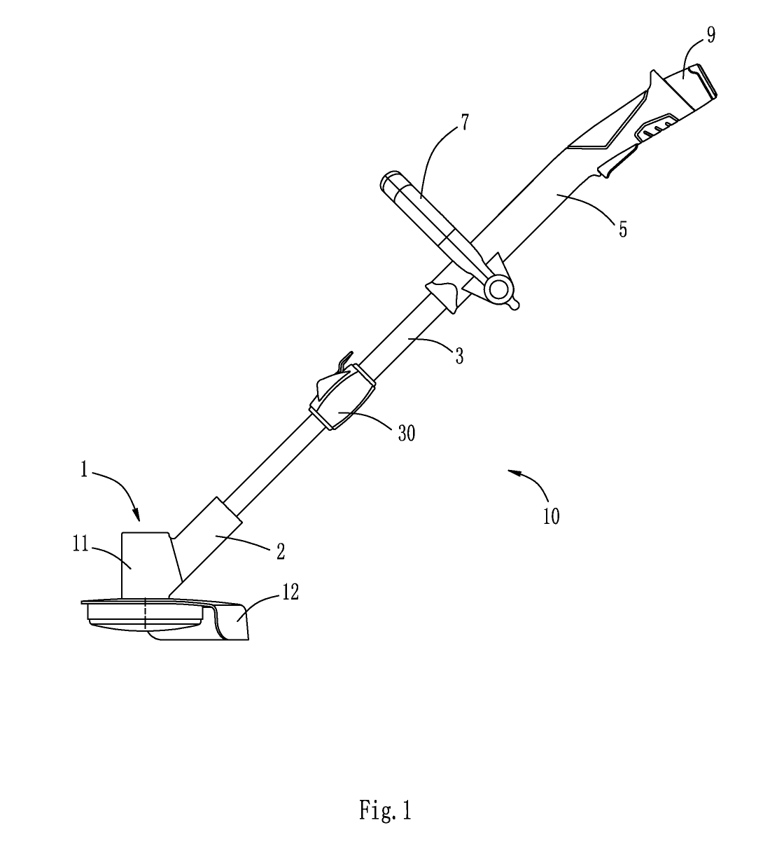

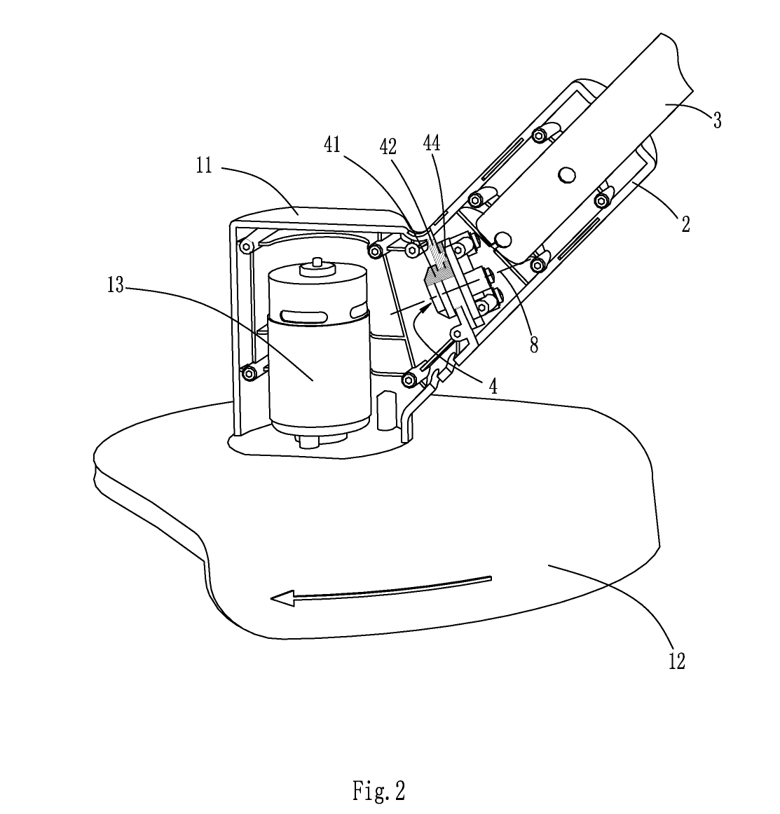

Referring to FIG. 1, the trimmer 10 according to the present invention includes a cutting head 1, a shaft rod 3 and a handle 5. The cutting head 1 and the handle 5 are mounted at the two ends of the shaft rod 3, respectively. An auxiliary handle 7 is arranged on the handle 5, so that the user can stably operate the trimmer 10 with both hands. Of course, the auxiliary handle 7 can also be mounted on the shaft rod 3 in other embodiments. The cutting head 1 comprises a motor housing 11, a shield 12 and a working element (not shown) for trimming. The motor housing 11 has the motor 13 mounted therein, as shown in FIG. 2. The working element can take the form of a flexible plastic wire member or linear member wrapped around a reel, or a plastic cutter element which is essentially rigid. A battery pack 9 is installed at the end of the handle 7 for powering the motor 13. In the illustrated preferred embodiment, the shaft rod 3 is a telescopic shaft including a locking device 30. Therefore, the user can adjust the shaft rod 3 to a comfortable operating length, and then lock it by the locking device 30 as required.

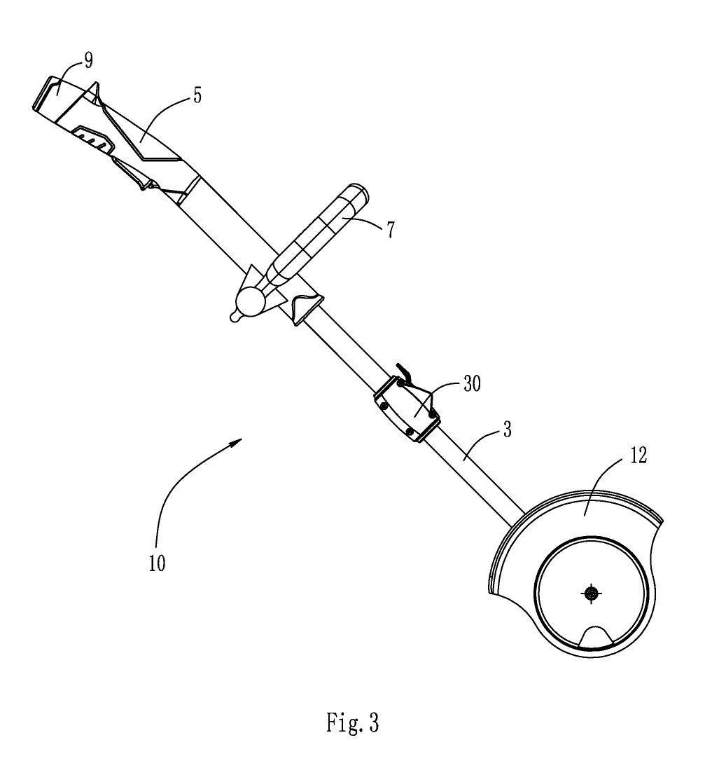

As shown in FIG. 2, a half of the motor housing 11 is removed to expose the motor 13 vertically installed in the motor housing 11. The lower end of the shaft rod 3 is fixed in a shaft housing 2, and in this figure, the half of the shaft housing 2 is also removed. The cutting head 1 is connected with the shaft housing 2 by a connection device 4. With the aid of this connection device 4, the cutting head 1 can be rotated to a vertical position around an inclined axis 8 relative to the shaft housing 2 and the shaft rod 3 into the edging mode as illustrated in FIG. 3, wherein the axis 8 is the central axis of the connection device 4.

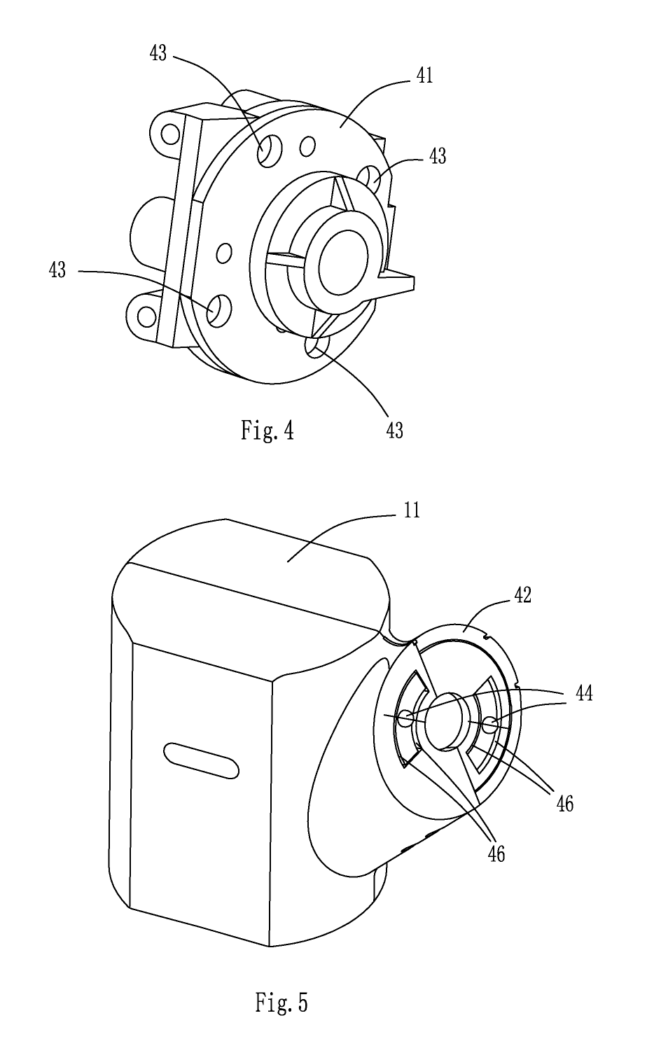

Referring to FIGS. 2 and 4, the connection device 4 includes a first connection element 41 and a second connection element 42, wherein the first connection element 41 is mounted on the lower end of the shaft housing 2 and has two pairs of centrosymmetric holes 43. In the embodiment, the first connection element 41 is substantially shaped as flange. Referring to FIGS. 2 and 5, the second connection element 42 is disposed at one end of the motor housing 11 which is adjacent to the shaft housing 2. The second connection element 42 includes a pair of hemispherical protrusions 44 which can be optionally mated with one pair of the holes 43. Curved grooves 46 are disposed on both sides of each protrusion 44 such that the protrusion 44 has certain flexibility in the direction perpendicular to the second connection element 42. As shown in FIG. 2, at the assembly state, the first connection element 41 and the second connection element 42 together define the rotation axis 8 which is angled at about 22.5° relative to the horizontal plane.

When the trimmer 10 is needed to be switched from the trimming mode shown in FIG. 2 to the edging mode shown in FIG. 3, the user only needs to turn the cutting head 1 to make it rotate around the axis 8 by 97.5°. When the protrusions 44 are rotated out of one pair of holes 43 and enter into the other pair of holes 43 with the rotation of the cutting head 1, the cutting head 1 is rotated from the horizontal position to the vertical position and then locked, so that the edging mode in FIG. 3 is achieved.

In other embodiments, the cutting head 1 can also be rotated around the axis 8 by other angle degrees to move between the horizontal position and the vertical position. Accordingly, the angle between the axis 8 and the horizontal plane can also be changed.

The trimmer thus disclosed is not limited to the contents given above and the structures shown in the figures. For example, the trimmer can be powered by an AC power supply besides the battery pack; the connection device is not limited to the specific structure in the above-mentioned embodiments and any connection device which can rotate two objects and lock them can be used to replace it. Any obvious modifications, substitutions or changes to the shapes and the positions of other components based on the spirit of the present invention will be regarded as falling within the scope of this invention.

What is claimed is:

1. A grass trimmer comprising: a cutting head, a shaft rod, and at least one handle, wherein the cutting head is rotatably mounted at one end of the shaft rod by a connection device with a central axis and the at least one handle is mounted at the other end of the shaft, and wherein the cutting head is movable between a horizontal position and a vertical position by rotating the cutting head 97.5° around the center axis.

2. A grass trimmer as claimed in claim 1, wherein the central axis is angled generally at 22.5° relative to the horizontal plane.

3. A grass trimmer as claimed in claim 1, wherein the connection device comprises a first connection element and a second connection element which are mated with each other, wherein the first connection element is fixed to the shaft and the second connection element is connected to the cutting head, and wherein the second connection element is rotatable together with the cutting head around the center axis relative to the first connection element.

4. A grass trimmer as claimed in claim 3, wherein the first connection element comprises holes, and the second connection element comprises protrusions and wherein the protrusions are mated with the holes.

5. A grass trimmer as claimed in claim 3, wherein the shaft is connected to a shaft housing at one end thereof adjacent to the cutting head and wherein the first connection element is connected to the shaft housing.

6. A grass trimmer as claimed in claim 1, wherein the cutting head comprises a motor housing, a shield, and a cutting element, wherein the shield is located under the motor housing, wherein a motor is mounted vertically in the motor housing, and wherein the motor housing and the motor are rotatable around the central axis.
